(19) United States
(12) Patent Application Publication
(10) Pub. No.: US 2008/0069624 A1
(43) Pub. Date: Mar. 20, 2008

(54) Paper Bundle Printer And Control Method For The Same

(75) Inventor: Hideki Sakano, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/847,206

(22) Filed: Aug. 29, 2007

(30) Foreign Application Priority Data
Sep. 19, 2006 (JP) 2006-253342

(51) Int. Cl. B41J 11/58

(52) U.S. Cl. 400/629

(57) ABSTRACT

A paper bundle printer includes: a platen roller that is disposed to face a bundle of a plurality of papers; a printing head that prints the bundle of the papers; a platen movement unit that moves the platen roller back and forth between a pick-up position facing the paper on the top and a printing position coming in contact with the printing head; and a control unit that exercises control over the platen roller, the platen movement unit, and the printing head, a paper-pick-up operation, a platen-moving-forward operation, a printing paper-feed operation of establishing a synchronization between paper feeding by the platen roller to the ejection slot and driving of the printing head, and a platen-moving-backward operation of moving the platen roller from the printing position to the pick-up position. In the paper bundle printer, the control unit sets a state of the platen roller being at the printing position as an operation start position for the printing process operation, and starts the printing process operation from the operation start position.

The entire disclosure of Japanese Patent Application No. 2006-253342, filed Sep. 19, 2006, is expressly incorporated by reference herein.

### BACKGROUND

1. Technical Field

The present invention relates to a paper bundle printer that prints a bundle of sticky note or others by peeling off the paper one by one, and a control method for the paper bundle printer.

2. Related Art

With a previously-known sticky note printer, i.e., paper bundle printer, applied with a printing system of printing a bundle of papers by peeling off the paper one by one, in a printing standby state, a platen roller is in contact with the sticky note on the top of the bundle thereof. As an example, refer to Patent Document 1 (JP-A-2003-212367). With such a sticky note printer, when a printing key is depressed, the platen roller responsively picks up the sticky note on the top, and moves the picked-up sticky note for sandwiching with a printing head. The printing head then prints the sticky note while the platen roller forwarding the sticky note sandwiched as such to an ejection slot. A user then removes the printed sticky note popping out of the ejection slot so that he or she can acquire any sticky note with his or her desired printing.

The issue here is that sticky note are often used as scratch papers, and in consideration of such a use, the sticky note printer is preferably of the configuration to be able to provide the sticky notes to a user whenever he or she wants those, i.e., right after a user command is issued for sticky note supply, the sticky note is expected to pop out of the ejection slot as soon as possible.

With the above sticky note printer, however, the printing process operation is started from picking up a paper, thereby resulting in a long time for the paper to pop out of the ejection slot. This is a problem for a user in view of usability of using the sticky note printer.

### SUMMARY

An advantage of some aspects of the invention is to provide a paper bundle printer that can reduce the time for a paper to pop out of an ejection slot, and a control method for the paper bundle printer.

According to an aspect of the invention, a paper bundle printer includes: a platen roller that is disposed to face a bundle of a plurality of papers whose one end portions are each detachable, and sequentially picks up one of the bundle of the papers on the top; a printing head that prints the bundle of the papers while working together with the platen roller to peel off one of the bundle of the papers on the top and forward the paper to an ejection slot; a platen movement unit that moves the platen roller back and forth between a pick-up position facing the paper on the top and a printing position coming in contact with the printing head; and a control unit that exercises control over the platen roller, the platen movement unit, and the printing head, and executes a printing process operation including a paper-pick-up operation, a platen-moving-forward operation of moving the platen roller from the pick-up position to the printing position, a printing paper-feed operation of establishing a synchronization between paper feeding by the platen roller to the ejection slot and driving of the printing head, and a platen-moving-backward operation of moving the platen roller from the printing position to the pick-up position. In the paper bundle printer, the control unit sets a state of the platen roller being at the printing position as an operation start position for the printing process operation, and starts the printing process operation from the operation start position.

According to another aspect of the invention, a control method for a paper bundle printer that executes a printing process operation, including: a paper-pick-up operation of sequentially picking up, at a pick-up position facing a bundle of a plurality of papers whose one end portions are each detachable, one of the bundle of the papers on the top by a platen roller; a platen-moving-forward operation of moving the platen roller from the pick-up position to a printing position coming in contact with a printing head, and sandwiching the picked-up paper with the printing head; a printing paper-feed operation of directing the sandwiched paper toward an ejection slot while peeling off the paper by the platen roller, and printing the paper using the printing head; and a platen-moving-backward operation of moving the platen roller from the printing position to the pick-up position after the printing paper-feed operation is completed. In the control method, a state of the platen roller being at the printing position is set as an operation start position during the printing process operation, and the printing process operation is started from the operation start position.

With such a configuration, because a state of a platen roller being at a printing position is set as an operation start position, a state of a paper being sandwiched between the platen roller and a printing head is a printing standby state. That is, a paper-pick-up operation and a platen-moving-forward operation are executed in advance before a printing process operation is started. As such, when a printing command is issued, a printing paper-feed operation is firstly executed, i.e., a printing job is executed while the paper being directed to an ejection slot. After a platen-moving-backward operation, the paper-pick-up operation and the platen-moving-forward operation are executed so that the platen roller is moved back to the operation start position again. This is the end of a series of printing process operations. As such, the time can be shortened because the time for the paper-pick-up operation and the platen-moving-forward operation can be omitted for a printing job, i.e., after the printing process operation is started and before the paper pops out of the ejection slot. With such a time reduction, the paper can come out of the ejection slot sooner. Note here that, the bundle of papers is exemplified by a bundle of sesticky note, a memo pad, or others.

In this case, the paper bundle printer is preferably further provided with a detection unit that detects, at the operation start position, whether any of the papers is picked up by the platen roller; and a notification unit that notifies, before execution of the printing process operation, when the detection unit detects “No” in terms of the papers, that none of the papers is picked up by the platen roller.

With such a configuration, due to any exchange failure of a bundle of papers, any paper pick-up failure, and others, when no paper is picked up by the platen roller at the operation start position, a user can be notified of such a fact.

In this case, preferably, the platen roller, the platen movement unit, the printing head, and the detection unit are provided in a paper bundle printer body, and the control unit and the notification unit are provided in a computer.

With such a configuration, through control over the paper bundle printer body utilizing a computer, the printing position of the platen roller can serve as an operation start position so that the time can be shortened before a paper pops out of an ejection slot.

### BRIEF DESCRIPTION OF THE DRAWINGS

The invention will be described with reference to the accompanying drawings, wherein like numbers reference like elements.

FIG. 1 is a schematic diagram of a sticky note printing system of an embodiment of the invention.

FIG. 2 is an external perspective view of a sticky note printer of the embodiment.

FIG. 3 is an internal schematic view of the sticky note printer of the embodiment.

FIGS. 4A to 4G are diagrams for illustrating a series of printing process operations of the sticky note printer.

FIG. 5 is a chart diagram for comparison between, in terms of a printing process operation, the sticky note printer of the embodiment and a previous sticky note printer.

### DESCRIPTION OF EXEMPLARY EMBODIMENT

In the below, by referring to the accompanying drawings, described is a case where a paper bundle printer of an embodiment is applied to a sticky note printer. The sticky note printer picks up a sticky note, i.e., paper, on the top of a bundle thereof set to a sticky note printer body, and prints the sticky note while peeling off the picked-up sticky note so that the printed is ejected out to the outside of the device. This is made by the sticky note printer body based on printing data edited by a personal computer.

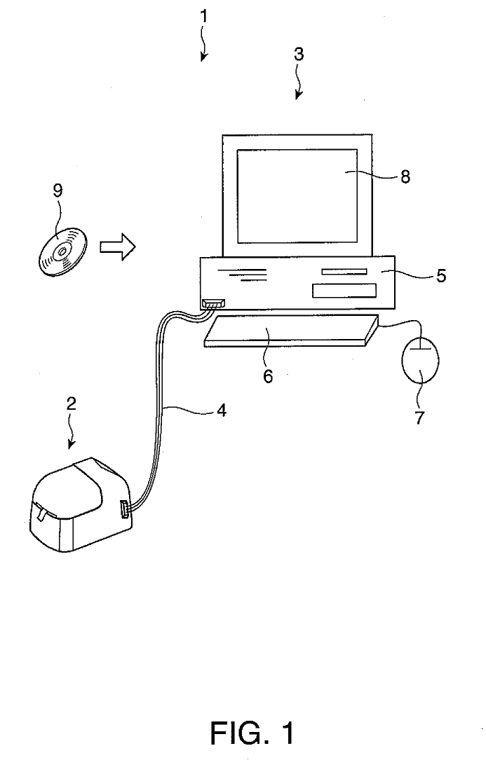

As shown in FIG. 1, a sticky note printer 1 is configured to include a sticky note printer body 2 and a personal computer (control unit) 3. The sticky note printer body 2 is set thereon with a bundle of sticky notesticky note H, and is connected with the personal computer 3 using a USB cable 4 or others. The personal computer 3 is in charge of generating and editing printing data for use for printing on a sticky note H1, and exercising control over various driving conditions of the sticky note printer body 2.

The personal computer 3 is configured to include a personal computer body 5, a keyboard 6, a mouse 7, and a display 8. The personal computer body 5 is connected with the keyboard 6 and the mouse 7, which are used for input of data, and the display 8 displays thereon the input result or others. The personal computer body 5 is detachably set with a CD-ROM (Compact Disk Read-Only Memory) 9, which is storing data related to the sticky note printer body 2, e.g., application software (program) and a device driver. When various detection signals, commands, data, and others are provided by the keyboard 6 or others, the personal computer 3 exercises control over the sticky note printer body 2 by processing the data varying in type in accordance with a program in the CD-ROM 9. Although the details are left for later description, the display 8 is configured as a notification unit that gives a warning or others by image display or audio, for example. The warning is given based on a result of detection by a detection sensor 23 provided inside of the sticky note printer body 2.

Although as a matter of course, printing to the sticky note H1 may be performed with the sticky note printer body 2 being provided with a function of generating and editing printing data and a function of exercising control over various other components, and the sticky note printer body 2 being used as a stand-alone.

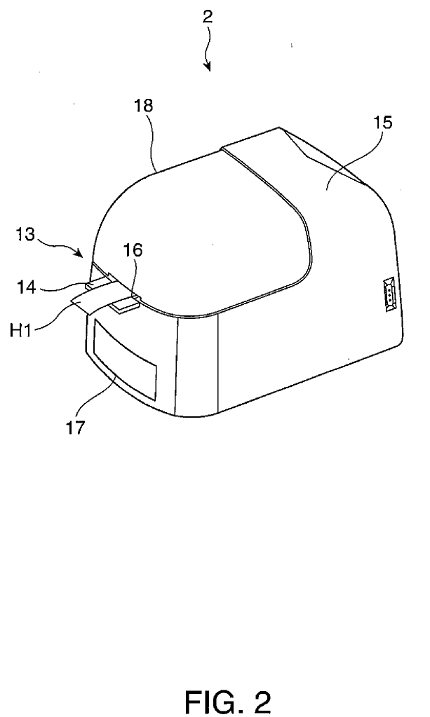

As shown in FIG. 2, the sticky note printer body 2 has a device case 15 serving as an outer case, and the device case 15 carries therein a bundle of sticky note H. The sticky note printer body 2 prints any desired character string created using the personal computer 3 to the sticky note H1 that is peeled off, one by one, from the bundle of sticky note H. The printing result is forwarded to an ejection section 13 formed to the device case 15 for output therefrom.

The device case 15 is formed small in its entirety, and on the lower front surface of the device case 15, a sticky note guide opening 17 is formed for loading a sticky note holder 20 (will be described later) like a drawer from the front toward inside of the case. The ejection section 13 is formed with an ejection slot 16 and a reception section 14. The ejection slot 16 is provided at the center of the upper front surface, and is formed like a horizontal slit for forwarding any printed sticky note H1 to outside of the case. The reception section 14 is formed extended from the inside to the outside of the case with the ejection slot 16 being the border for receiving the printed sticky note H1 after it is peeled off. The upper surface of the device case 15 is attached thereon with a ribbon cartridge C and an open/close lid 18. The ribbon cartridge C includes therein an ink ribbon R, and the open/close lid 18 is for use of maintenance.

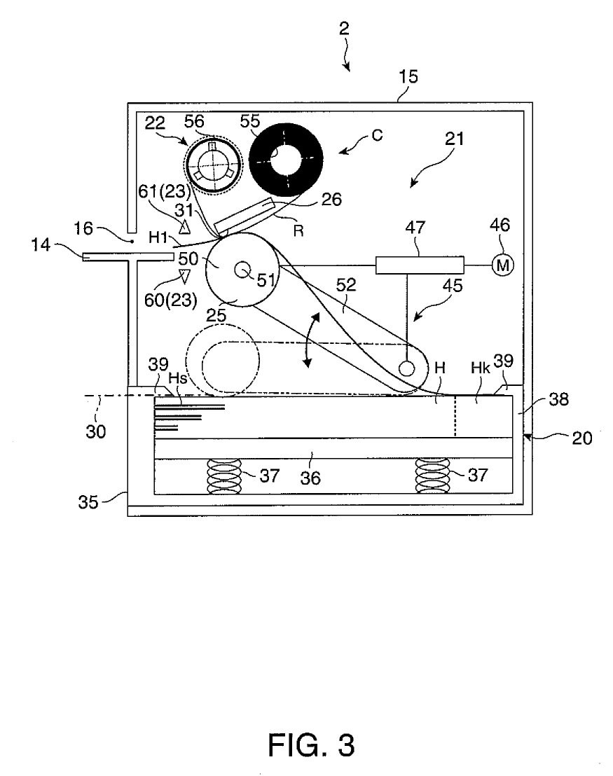

As shown in FIG. 3, the bundle of sticky note H is a plurality of sticky note H1 being piled up. The sticky note H1 is shaped like a rectangular, and is partially detachable at a base end portion Hk on the underside. The sticky note H1 is so configured as to be peeled off from the bundle of sticky note H, and after being peeled off, to be adhesive to a pad of paper or others via the detachable portion on the base end portion.

The sticky note printer body 2 is configured to include a sticky note holder 20, a sticky note transfer unit 21, a printing unit 22, and the detection sensor 23, which are all housed in the device case 15 described above. The sticky note holder 20 is provided for setting of a bundle of sticky note H. The sticky note transfer unit 21 includes a platen roller 25, and serves to pick up the sticky note H1 on the top of the bundle of sticky note H at a pick-up position 30, and peel off the sticky note H1 for transfer toward the ejection slot 16. The printing unit 22 includes a thermal head (printing head) 26, and serves to apply printing to the sticky note H1 on the way to the ejection slot 16 by working together with the platen roller 25. The detection sensor 23 serves to detect whether there is any sticky note H1 on a printing position 31. The platen roller 25 is so configured as to serve both a paper-feed roller for the sticky note transfer unit 21 and a platen roller for the printing unit 22.

As shown in FIG. 3, the sticky note holder 20 is configured by a sticky note bundle case 35 and a placement stage 36. The sticky note bundle case 35 is shaped like a box with the upper surface being left open. The placement stage 36 is housed in the sticky note bundle case 35, and the bundle of sticky note H is placed flat thereon. Between the placement stage 36 and the bottom surface of the sticky note bundle case 35, a coil spring 37 is provided for biasing upward the placement stage 36. The sticky note holder 20 is so configured as to be attached like a drawer to the device case 15, and is detachably attached via the sticky note guide opening 17. With such a configuration, for exchange and replacement of the bundle of sticky note H, the sticky note holder 20 is removed in its entirety, and the bundle of sticky note H is set thereon.

The sticky note bundle case 35 includes, as a piece, a square-frame-shaped case body 38 and a pair of position restriction sections 39. The square-frame-shaped case body 38 serves to guide the placement stage 36 to slide. The position restriction sections 39 are provided on the upper end portion of the case body 38, and are protruded inward to press a tip end portion Hs and the base end portion Hk of the bundle of sticky note H.

The placement stage 36 is shaped like a board, and is biased upward by four coil springs 37, for example. With the pair of position restriction sections 39, the sticky note H1 on the top of the bundle of sticky note H set on the placement stage 36 can remain at the same height level even if the bundle of sticky note H is reduced in thickness due to the transfer of the sticky note H1 one by one. At this time, the position where the bundle of sticky note H is set is the pick-up position 30 where the sticky note transfer unit 21 picks up the sticky note.

In the sticky note holder 20, when the bundle of sticky note H is set on the placement stage 36 from above the sticky note bundle case 35, the bundle of sticky note H is biased upward by the coil springs 37, and the tip end portion Hs and the base end portion Hk of the bundle of the sticky note H are so restricted as to be positioned flat at the pick-up position 30 by the pair of position restriction sections 39.

The sticky note transfer unit 21 is so configured as to pick up the sticky note H1 on the top of the bundle of sticky note H facing the pick-up position 30. The sticky note transfer unit 21 is configured to include the platen roller 25, a platen movement unit 45, a drive motor 46, and a speed-reduction gear train 47. The platen roller 25 comes in touch with the sticky note H1 on the top, and picks up and then peels off the sticky note H1. The platen movement unit 45 moves the platen roller 25 between the pickup position 30 and the printing position 31 at which the platen roller 25 comes in contact with the thermal head 26. The drive motor 46 serves as a drive source of the platen roller 25 and the platen movement unit 45. The speed-reduction gear train 47 serves to transfer the driving force of the drive motor 46 to the platen roller 25 and the platen movement unit 45.

The platen roller 25 comes in contact with the underside of the picked-up sticky note H1 on the tip end side, and peels off the sticky note H1 at the printing position 31 to rotate forward the paper. The platen roller 25 is configured to include a roller body 50 that directly comes in contact with the sticky note H1, and a roller drive shaft 51 serving as a rotary shaft of the roller body 50. The roller drive shaft 51 rotates in response to the power of the drive motor 46 coming via the speed-reduction gear train 47.

The platen movement unit 45 keeps hold of the roller drive shaft 51 at the tip end portion to be able to freely rotate, and includes a pair of rotation arms 52 each configured as to be able to freely rotate (swing) around the base end portion. The platen movement unit 45 is configured by, for example, a planetary gear mechanism and a cam mechanism. The planetary gear mechanism uses one of the rotation arms 52 as a carrier, and uses a part of the speed-reduction gear train 47. The cam mechanism converts the rotation force of the gear into the rotation movement of the rotation arms 52. That is, the cam mechanism converts the circular motion of the planetary gear mechanism into the reciprocating rotation movement of the rotation arms 52. With the reciprocating rotation movement of the rotation arms 52, the platen roller 25 is moved back and forth between the pick-up position 30 and the printing position 31, i.e., moves forward from the pick-up position 30 to the printing position 31, and moves backward from the printing position 31 to the pick-up position 30. The platen movement unit 45 is so configured as to place the platen roller at the printing position 31 in the initial state, i.e., printing standby state, and to start a series of platen reciprocating movements with the printing position 31 serving as an operation start position.

The printing unit 22 is configured to include the thermal head 26 and a ribbon take-up mechanism (not shown). The thermal head 26 is disposed in the vicinity of the ejection slot 16, and the ribbon take-up mechanism serves to take up the ink ribbon R of any attached ribbon cartridge C. The ribbon cartridge C is configured to include a ribbon dispenser reel 55, a ribbon take-up reel 56, and a cartridge case (not shown). The ribbon dispenser reel 55 is wound with the ink ribbon R for dispensing, and the ribbon take-up reel 56 takes up the ink ribbon R. The cartridge case houses therein the ribbon dispenser reel 55 and the ribbon take-up reel 56 to be able to freely rotate. When the platen roller 25 is moved to the printing position 31, the ribbon take-up mechanism is coupled to the above-described speed-reduction gear train 47 to receive the power from the drive motor 46, and in synchronization with the feeding of the sticky note H1, starts taking up, i.e., forwarding, the ink ribbon R.

The printing unit 22 configured as such performs a printing paper-feed operation with respect to the sticky note H1 under the control of a control signal over the thermal head 26 and the drive motor 46. The control signal is the one coming from the personal computer 3. That is, the sticky note H1 and the ink ribbon R are sandwiched between the platen roller 25 at the printing position 31 and the thermal head 26, and the printing unit 22 applies printing to the surface of the sticky note H1 while directing the sticky note and ink ribbon in the same direction. The printing is applied by heat generation driving of the thermal head 26.

The detection sensor 23 is configured by an optical sensor including a light receiving element 60 and light emitting element 61. The detection sensor 23 is disposed in the vicinity of the ejection slot 16 to pinch the tip end portion Hs of any picked-up sticky note H1. This is aimed to detect whether there is any sticky note H1 at the printing position 31 after being picked up by the platen roller 25.

At the operation start position (printing position 31), when the detection sensor 23 detects “Nonexistence” in terms of the sticky note, the detection result is input to the personal computer 3. In response thereto, a warning indicating that the platen roller 25 is picking up no sticky note H1 is displayed on the display 8 of the personal computer 3. With this warning, a user can know in advance that the printing job is to be executed with no sticky note H1, and after knowing as such, the user manually operates the sticky note printer body 2 to go through the paper-pick-up operation and the platen-moving-forward operation so that the sticky note H1 is sandwiched between the platen roller 25 and the thermal head 26, e.g., the user may operate a reset key for the paper-pick-up operation and the platen-moving-forward operation.

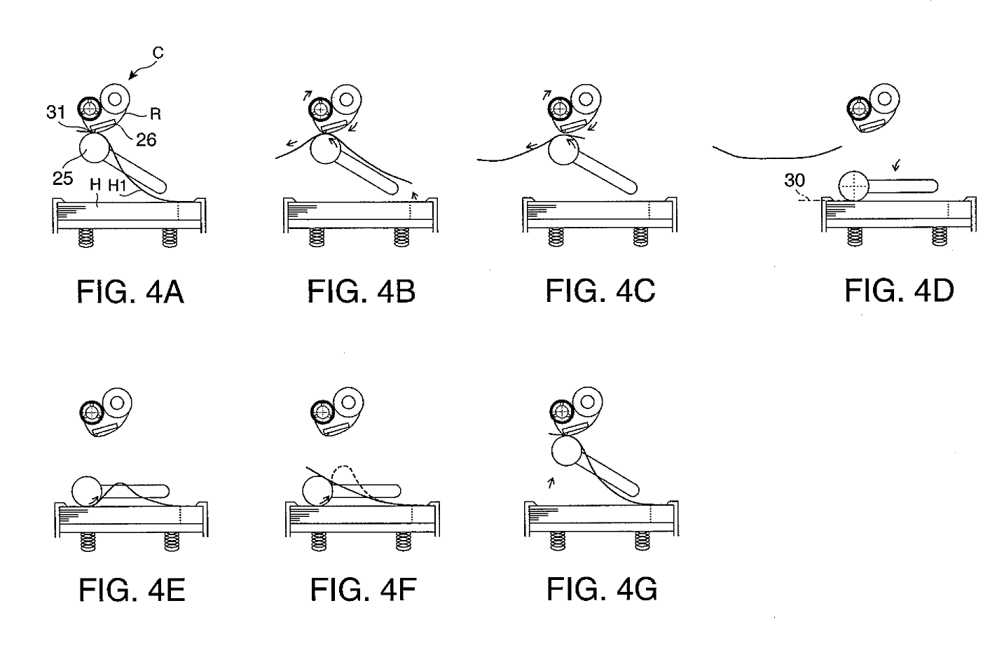

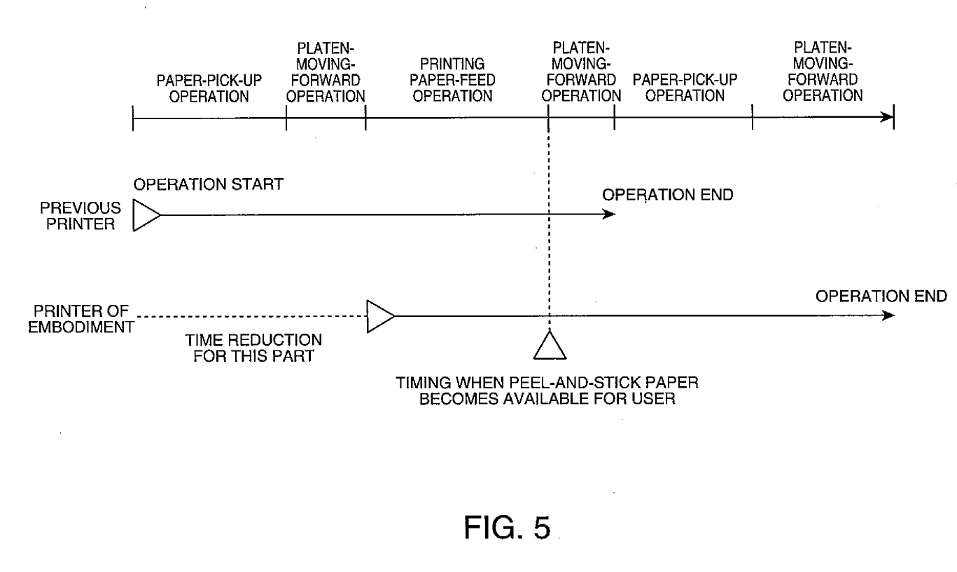

By referring to FIGS. 4A to 4G, described next is a series of printing process operations applied to a sticky note H1 in this embodiment. The printing process operation of this embodiment is compared with a previous series of printing process operations of the sticky note by referring to FIG. 5. In the printing standby state, the platen roller 25 is positioned at the printing position 31, and a sticky note H1 located on the top of the bundle of sticky note H set on the sticky note holder 20 is being sandwiched between the platen roller 25 and the thermal head 26 (see FIG. 4A). At this time, when the detection sensor 23 detects “Nonexistence” in terms of the sticky note H1, displayed on the display 8 is a warning indicating that no sticky note H1 is being picked up.

When a command of starting a printing job is issued from the personal computer 3 in the state that the detection sensor 23 detects “Existence” in terms of the sticky note, the platen roller 25 works together with the thermal head 26 to sandwich and peel off a sticky note H1 from the bundle of sticky note H. After peeling off the paper as such, the platen roller 25 rotates forwards the sticky note toward the ejection slot 16 with the tip end thereof being pointed thereto, and at the same time, starts the printing paper-feed operation, i.e., performs printing to the surface of the sticky note H1 from the tip end thereof (see FIGS. 4B and 4C).

When the adhesive portion of the sticky note H1 reaches the platen roller 25, the platen roller 25 starts the platen-moving-backward operation, i.e., moves backward from the printing position 31 to the pick-up position 30, and on the way to the pick-up position 30, passes the printed sticky note H1 to the reception section 14 (see FIG. 4D). At this point in time, the printed sticky note H1 provided to the reception section 14 becomes available for the user to take.

Thereafter, the platen roller 25 facing the pick-up position 30 rotates and starts the paper-pick-up operation, i.e., picks up the sticky note H1 on the top of the bundle of sticky note H. In response thereto, the platen roller 25 comes in contact with the surface tip end side of the sticky note H1 on the top so that the middle portion of the sticky note in the longitudinal direction gradually starts sagging as if being curved upward (see FIG. 4E).

Immediately after the tip end of the sticky note H1 being lifted upward as such passes through below the platen roller 25, the sticky note H1 is popped up above the platen roller 25 so that the tip end portion of the sticky note H1 is positioned on the platen roller 25 due to the rotation of the platen roller 25 (see FIG. 4F).

Thereafter, by the platen movement unit 45, the platen roller 25 is moved from the pick-up position 30 to the printing position 31, and a series of the printing process operations is ended with the sticky note H1 being remained sandwiched between the platen roller 25 and the thermal head 26 (see FIG. 4G).

With such a configuration, because the operation start position is set to the printing position 31, the printing process operation can be started from the state that the sticky note H1 is picked up and moved in advance to the printing position 31. As such, compared with the previous technology (see FIG. 5), the time can be shortened because the time for the paper-pick-up operation and the platen-moving-forward operation can be omitted for a printing job, i.e., after the printing process operation is started and before the sticky note H1 pops out of the ejection slot 16. With such a time reduction, the sticky note H1 can come out from the ejection slot 16 sooner than the previous technology. Note here that, in this embodiment, the bundle of papers is exemplified by the bundle of sticky note H. This is surely not restrictive, and alternatively, a memo pad or others are also possible options.

What is claimed is:

1. A paper bundle printer, comprising:
a platen roller that is disposed to face a bundle of a plurality of papers whose one end portions are each detachable, and sequentially picks up one of the bundle of the papers on the top;
a printing head that prints the bundle of the papers while working together with the platen roller to peel off one of the bundle of the papers on the top and forward the paper to an ejection slot;
a platen movement unit that moves the platen roller back and forth between a pick-up position facing the paper on the top and a printing position coming in contact with the printing head; and
a control unit that exercises control over the platen roller, the platen movement unit, and the printing head, and executes a printing process operation including a paper-pick-up operation, a platen-moving-forward operation of moving the platen roller from the pick-up position to the printing position, a printing paper-feed operation of establishing a synchronization between paper feeding by the platen roller to the ejection slot and driving of the printing head, and a platen-moving-backward operation of moving the platen roller from the printing position to the pick-up position; wherein
the control unit sets a state of the platen roller being at the printing position as an operation start position for the printing process operation, and starts the printing process operation from the operation start position.

2. The paper bundle printer according to claim 1, further comprising
a detection unit that detects, at the operation start position, whether any of the papers is picked up by the platen roller; and
a notification unit that notifies, before execution of the printing process operation, when the detection unit detects “Nonexistence” in terms of the papers, that none of the papers is picked up by the platen roller.

3. The paper bundle printer according to claim 2, wherein,
the platen roller, the platen movement unit, the printing head, and the detection unit are provided in a paper bundle printer body, and
the control unit and the notification unit are provided in a computer.

4. A control method for a paper bundle printer that executes a printing process operation, including:
a paper-pick-up operation of sequentially picking up, at a pick-up position facing a bundle of a plurality of papers whose one end portions are each detachable, one of the bundle of the papers on the top by a platen roller;
a platen-moving-forward operation of moving the platen roller from the pick-up position to a printing position coming in contact with a printing head, and sandwiching the picked-up paper with the printing head;
a printing paper-feed operation of directing the sandwiched paper toward an ejection slot while peeling off the paper by the platen roller, and printing the paper using the printing head; and
a platen-moving-backward operation of moving the platen roller from the printing position to the pick-up position after the printing paper-feed operation is completed, wherein a state of the platen roller being at the printing position is set as an operation start position during the printing process operation, and the printing process operation is started from the operation start position.
